(19) United States
(12) Patent Application Publication
(10) Pub. No.: US 2013/0253993 A1
(43) Pub. Date: Sep. 26, 2013

(54) SYSTEMS AND METHODS FOR MICRO-PAYMENTS AND DONATIONS

(71) Applicant: Chad Brower, San Jose, CA (US)

(72) Inventor: Chad Brower, San Jose, CA (US)

(73) Assignee: Yahoo! Inc., Sunnyvale, CA (US)

(21) Appl. No.: 13/427,554

(22) Filed: Mar. 22, 2012

(51) Int. Cl. G06Q 20/22; G06Q 99/00

(52) U.S. Cl. 705/12

(57) ABSTRACT

Micro-donations are received from users for various items of content published by different content providers. The micro-donations are aggregated into the user accounts and the content provider accounts until a transaction condition is satisfied. When the transaction condition is satisfied for the user account, a process to collect the micro-donation amount contributed by a respective user to different content providers is effectuated. When the transaction condition is satisfied for a content provider account, the micro-donation amount received from different users and aggregated within the content provider account is provided to the respective content provider. Various user and content provider incentives are implemented to encourage participation by the users and the content providers.

The present disclosure relates to micro-payment and donation systems and methods.

### BACKGROUND

The ubiquitous presence of the Internet in the modern era has placed the world of information and entertainment at our finger tips. The content available on the Internet can vary vastly in quality. Premium information or entertainment services require users to either pay a subscription fee on a regular basis or to pay per item of content. However, there is also a large amount of content on the Internet that is available without charge to the users. Certain websites facilitate user donations to content providers who publish content which users like.

### SUMMARY

This disclosure provides cent-vote systems and methods that facilitate receiving payments or donations from users who have received content and providing them to content providers or content publishers in a manner that minimizes the transaction costs so that a larger piece of the user donations can reach the intended content providers. Generally, these payments tend to be charitable donations of small amounts, i.e., micro-donations, that are made after the content is received by the user. This method provides greater flexibility to the users as they can designate not only the content providers who receive the micro-donations but also the amount of micro donations to be contributed to the designated content providers. Various embodiments described herein also relate to implementing user and content publisher incentives to encourage their participation in the cent-vote system.

In one embodiment a method of receiving user donations is disclosed. The method includes, receiving, by a computing device, user votes associated with at least one item of content. In one embodiment, the user votes are received via a button provided on a toolbar of a web browser that displays the item of content. In addition to user votes, the button can also facilitate receiving, user identification information and URL (Universal Resource Locator) of the at least one item of content automatically along with respective user votes. The received user votes are aggregated, by the computing device into respective user accounts. A micro-donation amount is associated with each of the user votes. In different embodiments, the micro-donation amount can be determined by the user or the content provider or can default to a predetermined value set within the cent-vote system if no user or content provider values are specified. The computing device, further determines if a transaction condition is satisfied for at least one of the user accounts and effectuates payments for the at least one user account for respective aggregated micro-donation amount upon the transaction condition being satisfied. In an embodiment, review of the aggregated micro-donations by a respective user of the at least one user account is also facilitated so that payment is effectuated for the at least one user account for the aggregated micro-donation amount only upon receiving confirmation to charge the aggregated micro-donation amount after the review by the respective user.

In addition to aggregating the user votes to respective user accounts, various user votes received for an item of content are aggregated, by the computing device into a respective content provider account. The computing device also determines if a transaction condition is satisfied for the content provider account and provides, at least part of the aggregated micro-donations to the content provider of the at least one item of content upon the transaction condition being satisfied for the content provider account.

In an embodiment, the transaction condition is satisfied when a preset time period has elapsed since the last payment. In an embodiment, the transaction condition is satisfied when the aggregated micro-donations exceed a predetermined threshold amount. Combinations of the threshold amounts and the time periods can also be employed to facilitate an implementation of the transaction condition. If a threshold amount is used, the threshold amount is set such that at least a predetermined amount of the aggregated micro-donations can be provided to respective content publishers after accounting for transactions costs.

In another embodiment, a computing device, comprising a processor and a storage medium for tangibly storing thereon programming logic associated with the cent-vote system, for execution by the processor, is disclosed. The programming logic comprises receiving logic, executed by the processor, for receiving user votes associated with at least one item of content.

In one embodiment, configuration logic, executed by the processor, configures a toolbar of a web browser, displaying the at least one item of content, to comprise a cent-vote button for receiving user votes. On receiving the user votes, aggregating logic is executed by the processor, for aggregating the received user votes into respective user accounts and a micro-donation amount is associated with each of the user votes by the associating logic executed by the processor. If it is determined by the processor that a transaction condition is satisfied for at least one of the user accounts, the at least one user account is charged for respective aggregated micro-donation amount. In an embodiment, the processor also facilitates review of the aggregated user votes to receive confirmation of the votes/micro-donations prior to charging the user for the micro-donation amounts. The aggregating logic further comprises, logic for aggregating, by the processor, the micro-donations associated with the user votes received for the at least one item of content into a respective content provider account. This facilitates the determining logic executed by the processor to determine if a transaction condition is satisfied for the content provider account. If the transaction condition is satisfied for the content provider account, the processor executes providing logic in order to provide at least part of the aggregated micro-donations to a content provider of the at least one item of content.

A computer readable storage medium, having stored thereon, instructions for execution by a processor is disclosed in accordance with another embodiment. The instructions cause the processor to receive, user votes associated with at least one item of content. The received user votes are aggregated by the processor into respective user accounts. A micro-donation amount is associated with each of the user votes by the processor. The processor further determines if a transaction condition is satisfied for at least one of the user accounts so that the at least one user account is charged for respective aggregated micro-donation amount upon the transaction condition being satisfied. In addition, the computer readable storage medium further comprises instructions that cause the processor to aggregate the micro-donations associated with the user votes received for the at least one item of content into a respective content provider account and determine, if a transaction condition is satisfied for the content provider account. At least part of the aggregated micro-donations are provided by the processor to the content provider of the at least one item of content upon the transaction condition being satisfied for the content provider account.

In one embodiment, a method of providing content is disclosed. The method comprises, receiving, by a processor, user votes representative of a monetary donations wherein the votes pertain to specific items of content published by content providers. The processor aggregates the monetary donations for each specific item of content voted by the users and at least part of the aggregated monetary donations are provided to a respective content provider a specific content item upon the satisfaction of a threshold condition. The processor additionally ranks, for each specific content item, the users who donated to the content item, based on their respective donations. In one embodiment, a list of the ranked users for each content item is transmitted to a respective content provider. In one embodiment, the users can be ranked per content provider. Therefore, the users are ranked according to the total amount they donate to various content items published by a particular content provider. In an embodiment, the users are ranked based on their total donations to a content provider summed over all the content items from that content provider. This facilitates implementing user incentives, such as, providing premium services associated with the content item or the content provider to respective donors. The privileges associated with the premium service can be based on ranking of the users with respect to their donations. In addition, the processor also ranks, each of the specific items of content based on the donations received by each content item and provides a list of ranked items to the content providers so that they can identify content that is popular among users. In an embodiment, a respective rank of the items of content are displayed to users viewing the items. In a further embodiment, the items of the content voted by users can also be provided to respective social contacts.

The method additionally involves receiving a topic assigned to one of the items of content by a user who voted for the content item, such that, the content item is classified under the assigned topic for a user profile associated with the user in accordance with one embodiment. In further embodiments, the topic is selected from a taxonomy which was associated with the content item by a provider of the content item or the assigned topic is generated by the user or the topic can be automatically set by the processor. The topic assigned by the user can also be displayed for selection by other users in order to classify the content item under the assigned topic for their respective user profiles. If it is determined by the processor, that the number of users who selected the assigned topic to classify the content item for their respective user profiles exceeds a predetermined threshold number, the content item can also be classified under the assigned topic in a topic page that is accessible to all the users. In a further embodiment, topics associated with the specific items of content are ranked based on user votes received for each of the topics and such a ranked list of topics is shared with the content providers. Thus, the method can facilitate identifying new topics or categories for content in addition to identifying topics that are popular among the users.

A computing device for providing content is disclosed in accordance with yet another embodiment. The computing device comprises a processor and a storage medium for tangibly storing thereon program logic for execution by the processor. The program logic comprises receiving logic, executed by the processor, for receiving user votes for specific items of content published by content providers wherein the user votes are representative of monetary donations made by the users to the content providers after the users have seen or received the content items. Aggregating logic, executed by the processor, aggregates the monetary donations per content provider such that the total donations for different items of content published by a content provider and voted by the users are aggregated. At least part of the aggregated monetary donations are provided to a respective content provider upon the satisfaction of a threshold condition. In addition, the users are ranked based on their respective donations to a specific content provider and a list of ranked users is transmitted to the content provider.

A computer readable storage medium, having stored thereon, instructions for execution by a processor is disclosed in accordance with an embodiment. The instructions cause the processor to receive user votes representative of monetary donations wherein the votes pertain to specific items of content published by content providers. The monetary donations for each specific item of content voted by the users are aggregated and at least part of the aggregated monetary donations are provided to a respective content provider of a specific content item upon the satisfaction of a threshold condition. For each specific content provider, the users who donated to the various content items from the content provider are ranked based on respective donations and a list of ranked users is made available to the content provider so that the top donors who are eligible to receive premium treatment can be identified in accordance with different embodiments described herein.

In accordance with one embodiment a method of facilitating micro donations is disclosed. The method comprises displaying, by a computing device, an item of content and a button that records a user vote indicative of monetary donation for the item of content by a user. A user vote for the item of content is received by the computing device when the button is activated by the user. The received user vote, respective user information and information regarding the item of content are transmitted by the computing device to a server.

These and other embodiments and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a block diagram of a user computer communicating with one or more server computers over a network in accordance with an embodiment of the present disclosure;

FIG. 2a is a block diagram depicting certain modules within the cent-vote system in accordance with an embodiment of the present disclosure;

FIG. 2b is a block diagram depicting certain modules within the cent-vote system in accordance with an embodiment of the present disclosure;

FIG. 3 is a block diagram of an example of a screen display that includes a cent-vote button in accordance with one embodiment;

FIG. 4 is a block diagram of an example of a screen display that includes the placement of the cent-vote button in accordance with one embodiment;

FIG. 5 is a block diagram of an example of a screen display that includes the placement of the cent-vote button in accordance with an embodiment;

FIG. 6 is a block diagram of an example of a screen display that includes a review page associated with a user account in the cent-vote system in accordance with one embodiment;

FIG. 7 is a schematic figure of a system that facilitates websites to register with the cent-vote system in accordance with one embodiment;

FIG. 8 is a block diagram of an example of a screen display that includes a process of assigning special privileges to a top donor of a website in accordance with an embodiment of the present disclosure;

FIG. 9 is a block diagram of a screen display wherein content receiving cent-votes from users is transmitted to a user's social network in accordance with one embodiment;

FIG. 10 is a block diagram of a screen display that provides value added content to users in accordance with one embodiment;

FIG. 11 shows a flowchart illustrating an embodiment of a method of facilitating micro-donations from users in accordance with one embodiment;

FIG. 11a shows a flowchart illustrating an embodiment of a method of facilitating micro-donations from users in accordance with one embodiment;

FIG. 12 is a flowchart illustrating an embodiment of a method of providing premium services from content providers to their respective top donors in accordance with an embodiment;

FIG. 13 is a flowchart that illustrates an embodiment of a method of recognizing popular content categories in accordance with one embodiment;

FIG. 14 is a flowchart that illustrates an embodiment of a method of categorizing content in accordance with one embodiment;

FIG. 15 is a block diagram illustrating an example of an internal architecture of an example of a computing device in accordance with an embodiment of the present disclosure;

FIG. 16 is a schematic diagram illustrating a client device in accordance with embodiments of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The Internet provides large resources of information and entertainment, some of which may require payment while other resources are available free of cost to the users. In may instances users would choose paid service over free service, if the paid service is much more easier, provides a better quality experience and is cheap enough. Generally, payments must be proportional to the entertainment value of the webpage. Some issues that users face while paying to receive Internet content could be that they like only part of the content and would rather not pay upfront for the entire content as would be the case when signing up for a periodic subscription to a website. They may also be unwilling to pay for content before actually receiving it as they may be doubtful about its quality. Another reason is that users are cautious about providing their payment information to numerous, unknown content publishers. Content publishers, on the other hand, desire easy revenue streams for greater profitability. Banner advertisements included in the webpage or pop-up advertisements associated with web-pages are some tools that content publishers can employ to generate revenue streams from online content. However, not all content can attract advertisement revenue. Some content may not be attractive to advertisers since, for example, it may not match the attributes of products they are advertising or the websites may be too small or too specialized to generate considerable revenue. In addition, user behavior such as employing pop-up blockers in web browsers also contributes to hampering revenue generation efforts of the content providers/publishers. Various embodiments described herein provide for revenue generation by content providers in a manner that minimizes transactional costs and implementation efforts while addressing the concerns of the users in paying for such content.

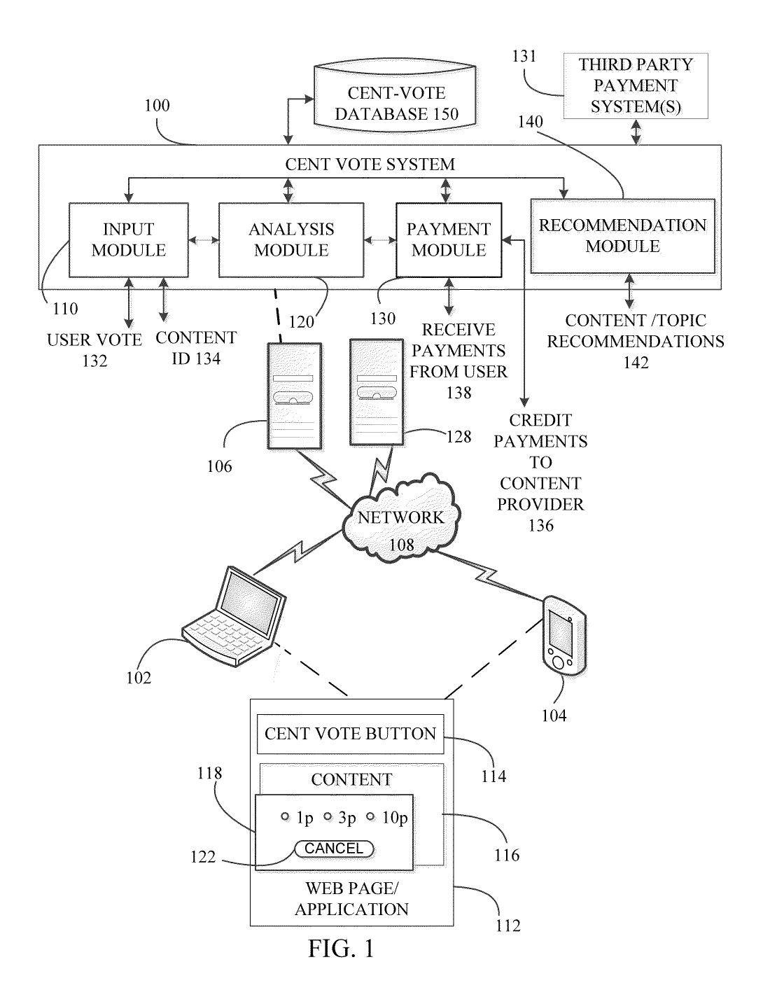

Turning now to the figures, FIG. 1 is a block diagram of an embodiment wherein a user computer/client device 102 or 104 communicates with a server computer 128 over a network 108 such as the Internet. The client devices 102/104 are employed by users to display a web page or an application for a computer or mobile device or a gaming system 112 including an item of content 116 being provided by the server computer 128. In different embodiments the webpage may be been directly accessed by the user by entering the URL of the webpage into the address bar of the web browser or it may have been accessed via a search engine and the content item 116 may be text data, audio or video content or combinations thereof. In addition to providing the item of content item 116, the webpage 112 can have associated therewith a cent-vote button 114 that enables a user to vote for the content 116. In a further embodiment, each user vote can be associated with a predetermined amount, for example, one cent, so that when the user clicks on the cent-vote button 114 once, one cent will be recorded in the user account as the user's contribution to the content item 116. Therefore, the cent-vote system 100 provides for the users to pay only upon accessing the content which can enable them to determine how much they would like to contribute or donate to the content.

In different embodiments, the cent-vote button 114 can be included in the application or the webpage 112, on the browser toolbar or as a bookmarklet. Including a button 114 on the webpage 112 requires the provider of the content 116 to include code associated with the cent-vote button 114 into the webpage 112. If the cent-vote button 114 is configured as a toolbar button on the web browser or as a separate toolbar, no coding is required by the provider of the item of content 116 to accommodate the cent-vote button 114. In a further embodiment, the cent-vote button 114 can be placed on the toolbar at a consistent position. This can mitigate the need for content developers to assign space within the webpage 112 for the cent-vote button 114 so that the content provider has more space in the webpage 112 for the item of content 116 itself. In addition, it can also reduce the implementation costs and efforts associated with adopting the cent-vote platform as the provider does not need to include additional code within the webpage 112 for the cent-vote button. Instead, the cent-vote button 114 can operate from the toolbar itself thereby facilitating easier adoption of the cent-vote platform by different websites. When the cent-vote button 114 is placed on the toolbar, a further embodiment can be implemented wherein the cent-vote button 114 is rendered active if the content provider of the webpage 112 currently being viewed is registered with the cent-vote system 100 or the cent-vote button 114 can be rendered inactive if the content publisher is not registered with the cent-vote system 100. In another embodiment, the cent-vote system 100 can display a message to a user upon clicking the toolbar cent-vote button 114 that the webpage currently being viewed for which the user desired to donate/vote is not registered with the cent-vote system 100 and hence donating for that particular item of content is not possible.

In one embodiment, clicking the cent-vote button 114 will initiate a log in process for the user. In another embodiment, the users can continue to view the item of content 116 without interruption upon clicking the cent-vote button 114. When a user clicks on the cent-vote button 114, the user vote information 132 and the content identification 134 such as the URL (Universal Resource Locator) of the webpage 112 are automatically transmitted without requiring the user to log in to the cent-vote system 100. Therefore, while casting the votes, users stay on-page viewing the content item 116. Hence, such arrangement facilitates receiving user feedback and donations while causing minimum distraction to the users who are viewing the content.

In one alternative embodiment, when a user clicks on the cent-vote button 114, a notification can be transmitted to the user, for example, as a pop-up window 118 on the webpage 112. The pop-up window 118 displays various options to the user regarding the user's contributions. For example, the user can choose to contribute one of one, three or ten pennies or other amounts to the webpage 112 or they user may choose not to contribute by clicking the cancel button 122. Upon the user selecting one of the options, the user vote information 132 and the content identification 134 such as the URL (Universal Resource Locator) of the webpage 112 on which the cent-vote button 114 was included is transmitted from the user/client devices 102/104 via the network 108 to the cent-vote server 106. In another embodiment, clicking the cent-vote button 114 can directly provide the user vote information 132 and the content identification information 134 to the cent-vote server 106 wherein a default amount is associated with each user vote within the cent-vote system 100 being executed thereon so that the user's attention is not diverted from the content item 116 of the webpage 112.

The cent-vote system 100 comprises an input module 110, an analysis module 120, a payment module 130 and a recommendation module 140. Although FIG. 1 shows three modules within the cent-vote system 100, it can be appreciated that this is by the way of illustration and not limitation. The functionality described herein can be achieved by more or less number of modules. The information transmitted from the user computer/client device 102/104 is received by the input module 110. In one embodiment, the cent-vote button 114 can be configured so that the user can be logged in automatically and the information associated with the user vote 132 that is transmitted to the cent-vote server 106 includes identification information of the user. For example, if the user has a cent-vote toolbar (not show) or has a browser toolbar with the cent-vote button 114 installed on it, clicking the cent-vote button 114 on such a toolbar can automatically transmit the user identification information to the input module 110 of the cent-vote system 100. In another embodiment, upon receiving the user vote 132, the input module 110 can require the user to enter the user identification information, such as by directing the user to a log in process thereby obtaining the identification of the user who is voting for the content item 116. In a further embodiment, the input module 110 can also be configured to receive tags or topics selected by the user in order to categorize the content item 116 along with or subsequent to receiving the user's cent-vote.

The analysis module 120 of the cent-vote system 100 receives the information associated with the user vote 132 and the content identification 134 collected by the input module 110. As the payments associated with the user votes are small, sometimes penny payments, they are aggregated over time by the cent-vote system 100 in order to handle them without being overwhelmed by the transaction costs. In one embodiment, the information thus received can be stored or aggregated in one or more databases 150 comprised within or communicatively coupled to the cent-vote system 100. Therefore, the identification of the user and the content id 134 associated with the vote 132 can be stored in the database(s) 150. The database(s) 150 is configured to aggregate votes received from a plurality of users for different websites into respective user accounts. Thus, for each user and each website, the votes received are stored or aggregated within the database(s) 150 into respective user and content publisher accounts. Additionally, the analysis module 120 examines or determines if a transaction condition is satisfied for a user account associated with the user vote 132 or for the website/content provider account associated with the content id 134 in order to trigger a payment process. In different embodiments, the transaction condition can be based on a threshold amount of money or a threshold time period or combinations thereof. For example, based on the predetermined amount associated with each vote and the total number of votes for various websites logged by the user, a predetermined threshold amount that will satisfy the transaction condition may have accumulated in the user account.

When it is determined by the analysis module 120 that the transaction condition is satisfied for the user account or the website associated with the user vote 132, the payment module 130 executes the payment process for the user and/or the website. If the transaction condition is satisfied for a user, a payment procedure is executed by the payment module 130 to collect payments 136 from the user for the aggregated votes as will be detailed further herein. In another embodiment, if the transaction condition is satisfied for a website or the provider associated with the content id 134, the payment module 130 will initiate a payment procedure to credit payments 138 to the content provider. Although the payment module 130 is shown as being comprised within the cent-vote system 100, it can be appreciated that this is not necessary. For example, the cent-vote system 100 can be configured to employ other payment platforms such as Yahoo Wallet or PAYPAL or credit card or debit systems, mobile payment services or other banking or payment system now known or to become known, in order to process payments. Thus, the actual charging for payment can be made a function of the cent-vote system 100 through directly handling the charges or may be effectuated via a communication with third party payment systems 131 or payment system(s) associated with the cent-vote system 100 which may or may not be operated by the operator of the cent-vote system 100. This can thus facilitate implementing a vote-now-pay-later model wherein users can pay voluntarily after they have seen/evaluated the content.

In addition to facilitating revenue generation for the various content providers, the cent-vote system 100 also comprises a recommendation module 140. The recommendation module 140 is configured to rank various entities such as users, topics and/or content items based on different criteria as will be detailed further infra. This facilitates providing content recommendations 142 to users and conversely, for identification of user segments to content providers. As the users actually support their votes with their donations, it can be determined with greater confidence that content receiving more donations will be of higher quality or will be better liked by the corresponding user segments. Thus, the cent-vote system 100 acts as a central aggregator that collects all the user votes and aggregates them to determine popular content.

The recommendation module 140 can be communicatively coupled to other modules of the cent-vote system 100 in order to receive information regarding user votes for different content items, user donations, user supplied tags or selections from existing taxonomies and user/publisher participation in different incentives. In one embodiment, the recommendation module 140 can also be employed to implement various incentive schemes for users and content publishers. The cent-vote system 100 can provide API (application programming interfaces) to publishers to grant custom rewards to users, for example, based on user donations. The incentive schemes can include identifying top donors for each website or content provider so that the content provider can assign special privileges to such donors, for example, providing premium content, fewer advertisements or identifying the top donors on respective web page. In a further embodiment, the code associated with the cent-vote button 114 can attempt to block any advertisements on the voted webpage for the remainder of the day. In another embodiment, the user votes can be aggregated to enable games wherein users compete to be publicly recognized as a top sponsor of popular websites. In another embodiment, the user votes can be aggregated by topic area to provide high-quality content recommendations as a web portal website for browsing. In further embodiments, the recommendation module 140 can provide as recommendations to a user, content voted for by others in the user's social network. Thus, user votes can be broadcast to the user's social network (at the user's discretion) as a high-quality content recommendation notification stream. Therefore, the cent-vote system 100 can provide a two-way benefit for both content providers in terms availability of more funding and for users in terms of access to more interesting content, and premium treatment at preferred websites.

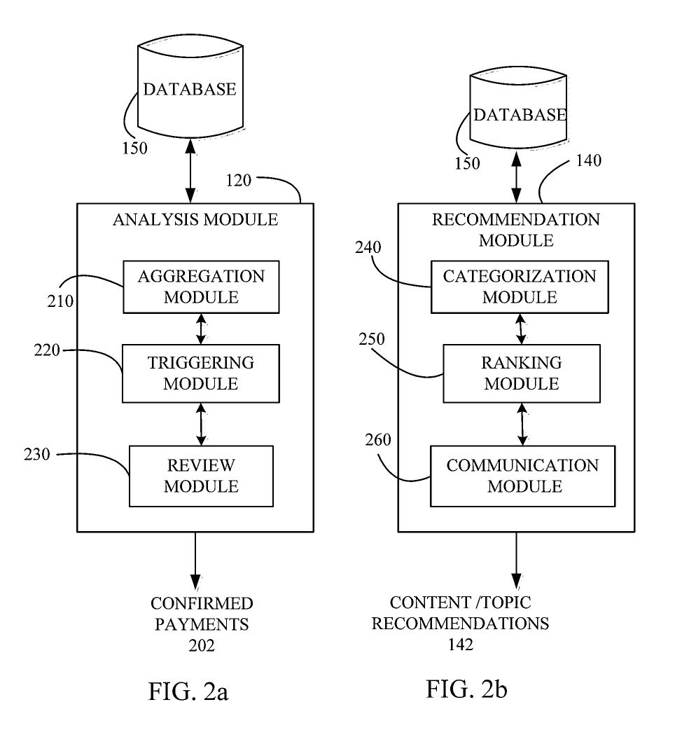

FIG. 2a is a detailed block diagram of the analysis module 120 included in the cent-vote system 100. The analysis module 120 comprises an aggregation module 210, a triggering module 220 and a review module 230. The aggregation module 210 is configured to aggregate votes received into accounts of the respective users and the websites associated with each of the votes. As discussed supra, each user vote is associated with a small amount of money, for example, one cent, which is added to the user's account for future debit and to the website's account or the content provider's account for future credit. Each time a user votes for a website, one cent or other amount is accumulated into the user's account by the aggregation module 210, for collection at a later time, such as, when a transaction condition is satisfied. While a minimum amount associated with each user vote can be preset to a default value within the cent-vote system 100, a user can also be allowed to associate a higher amount with respective votes as one of the attributes associated with the user account. Aggregating user votes/contributions as described herein leads to a simpler system wherein no specified funding ratios need to be determined and users have more control over the amounts they contribute to different websites.

Similar features can be implemented with accounts associated with content providers wherein a content provider can associate a micro-donation amount with the user votes received for respective content that is different from the amount preset within the cent-vote system 100. Alternately, the content publisher can specify or customize within the cent-vote system 100 the minimum amount the publisher is willing to accept with each user vote. The amount associated with user votes can be determined by the content publisher based on different criteria. For example, the amount associated with the user votes can depend on the content wherein user votes for content with greater value will have associated therewith higher micro-donation amount in accordance with one embodiment. In another embodiment, a website/content publisher may allow user votes to be associated with a minimum default value preset within the cent-vote system 100 for premium users who donate frequently, whereas for other users who donate less frequently, each user vote will be associated with a higher micro-donation amount. The aggregation module 210 will accordingly associate the specified amount with each vote received from users for the content or webpage of the content provider and the corresponding amounts will be added for processing to the users' and the content provider accounts. In a further embodiment, if the amount specified by the content provider is different from the default amount preset in the cent-vote system 100, the user can be informed of the amount at the time of voting or during a review prior to confirming payment.

Although a user can contribute more than one cent, in one embodiment, only one user vote will be associated with each contribution made by the user within a predefined time period. This facilitates the cent-vote system 100 to keep an accurate count of unique user votes that each website or each unique content receives. For example, if the content of a particular URL is changed, the cent-vote system 100 may recognize such a change and count the user vote for the new content as another unique vote even if it is received prior to the expiration of the predefined time period. Conversely, if the contents of the URL remain unchanged even after the expiration of the predefined time period, multiple contributions from a user to the URL can be counted as one vote. In a different embodiment, the number of user votes can be proportional to the amount of micro-donations received from the users. For example, a donation of five cents from a user can be counted as five votes. In each case, the aggregation module 210 receives the information associated with the user vote 132 and logs the information into respective user and content provider accounts in the cent-vote database 150.

The triggering module 220 determines if a transaction condition is satisfied for the user and/or the content provider associated with the user vote 132 and the content id 134. The transaction condition can be based on threshold time and/or threshold amount accumulated in the user/provider account. If the amount associated with user votes and accumulated in the user account is greater than or equal to a threshold value predefined within the cent-vote system 100, the triggering module 220 can trigger procedures to collect payment from the user. Similarly, when the triggering module determines that a predefined threshold time period has elapsed the payment procedure is initiated. In a different embodiment, a combination of these factors can be used to trigger the payment process. For example, if the amount accumulated in the user/content provider account exceeds the threshold amount even prior to the predetermined time period, the payment procedure can be initiated.

In a further embodiment, the threshold amount to be accumulated in the user/content provider account in order to trigger the payment process can be set to a minimum value that will justify the transaction costs associated with the payments. For example, in the case of a user contributing to different websites, the payment procedure can be initiated only if a predetermined portion of the donations can reach each of the content providers or the websites after accounting for the transaction costs. The transaction costs associated with the payment process can include, for example, one or more of the charges levied by a third party payment platform to process the transaction or the charges associated with the maintenance of the cent-vote system 100.

Similarly, the triggering module 220 initiates a payment process for a website when the donations accumulated in the account associated with the website exceed the threshold amount which is set in a manner that sizable portions of the donations reach the provider of the website after accounting for the transaction costs. In a further embodiment, it can be appreciated that the transaction condition with respect to the threshold amount for a website provider associated with the content ID 134 can be satisfied only upon receiving payments from all the users who voted for the content 116 within a predefined time period. In this embodiment, the cent-vote system 100 can initially classify votes received for a website as unfunded votes. Upon receiving payments from the users for the votes, they are converted or re-classified as funded votes. Therefore, the payment process to credit received donations to a website publisher or content provider can be initiated only if the amount associated with the funded votes for a website equals or exceeds a threshold amount. In a further embodiment, if a combination of threshold amount and threshold time period is being implemented for a website and the funds do not reach the threshold amount, the payment to the content provider can be delayed until the next pay cycle so that loss of revenue in transaction costs can be mitigated.

When the triggering module 220 initiates a payment procedure for a user, the user can be provided an opportunity to review the aggregated votes and the amount associated therewith by the review module 230 before confirming payment in accordance with a further embodiment. This provides an opportunity for the user to rescind/postpone/increase the contribution made to a website at a later stage. If the edits made to the contributions by the user upon review cause the total amount accumulated in the user account to fall below the threshold amount preset in the cent-vote system 100, the user payment can be postponed until the threshold amount is reached again. When the user confirms the contributions made to different providers upon review, the payment module 130 can receive the confirmed payments 202, retrieve the payment information such as the credit/debit card, PAYPAL login/password information or other payment information associated with the user account in order to effectuate the payments. The cent-vote system 100 is therefore structured in a manner that encourages the users to participate, not only because the amount associated with the votes is quite small, but also because it facilitates users to determine how much they would like to contribute to the content.

FIG. 2b is a schematic diagram illustrating the details of the recommendation module 140. The recommendation module 140 comprises a categorization module 240, a ranking module 250 and a communication module 260 which in conjunction with other modules of the cent-vote system 100 facilitate implementing various user and content provider incentives to encourage their participation in the cent-vote system 100. Again, it may be appreciated that the analysis module 120 and the recommendation module 140 are shown in FIGS. 2a and 2b with three modules each by the way of illustration and not limitation and that the functions described herein can be achieved by greater or lesser number of modules.

The categorization module 240 is configured to receive or provide a topic or assign categories or tags to content items and/or user votes. In an embodiment, the information regarding the categories can be retrieved from the database 150. This classification of content items and user votes can be employed by the ranking module 250 to identify popular topics as will be detailed further herein. In different embodiments, the categorization module 240 can have predetermined topics associated with each of the content items provided to the users. In one embodiment, these topics can be predetermined by the content providers or they can be preset within the cent-vote system 100 based, for example, on input from human editors or the content items may have been automatically classified by employing natural language processing techniques. In a further embodiment, the categorization module 240 is configured to permit the users to define or generate new content categories or associate new topics/tags with the content items. In this embodiment, the users are provided an opportunity to classify the content item 116 at the time of voting. The users can select from preexisting categories or they can supply their own category or topic under which the content item 116 is categorized for their respective user profiles for later retrieval. In addition, the user votes are also aggregated for each of the topics existing within the cent-vote system 100. In an embodiment, a new content topic defined by a user can be made accessible for selection by other users of the cent-vote system 100. In this embodiment, the level of accessibility can be based on the account or the privacy settings associated with the user who generated the new topic. Thus, a new topic or tag generated by one user to categorize a content item, for example content item 116, can be selected by other users to categorize the content item 116 under their respective profiles. Based on the number of users who select the new user-generated topic for classifying the content item 116, such user-generated topic can also be included in a topic page of the cent-vote system 100 having the content item 116 associated therewith. Therefore, the cent-vote system 100 is configured to allow users to define their own topics in classifying content items and if these topics gain sufficient popularity, they can be promoted to be universally available within the cent-vote system 100.

The ranking module 250 is configured to rank entities, such as, users, items of content and topics/categories/tags assigned by the users to the various content items. In an embodiment, the users who contribute or donate to an item of content 116 or a provider of the content item 116 can be ranked based on their contributions to the content item 116 and such rankings can be communicated to the provider of the content item 116 by the communication module 260. In particular, the users who donated to the content provider are ranked based on respective donations summed over all content items published by the content provider of the content item 116. This facilitates the content provider to identify the top donors and recognize their donations by providing special privileges such as premium content or ad-free service for a specified time period. The ranking module 250 can also provide ranked lists of content items via the communication module 260 to the various content providers so that popular content items can be identified by the content providers who can then employ such rankings to organize their content so that popular content has greater visibility or is more easily retrieved by the users. In an embodiment, the ranking module 250 in conjunction with the categorization module 240, can also additionally generate ranked lists of topics/categories/tags. These ranked lists of topics can also be communicated to the content providers. The content providers can employ such topic rankings in not only organizing content or but also in generation of content so that greater amount of content associated with such popular topics is generated as compared to the less popular topics.

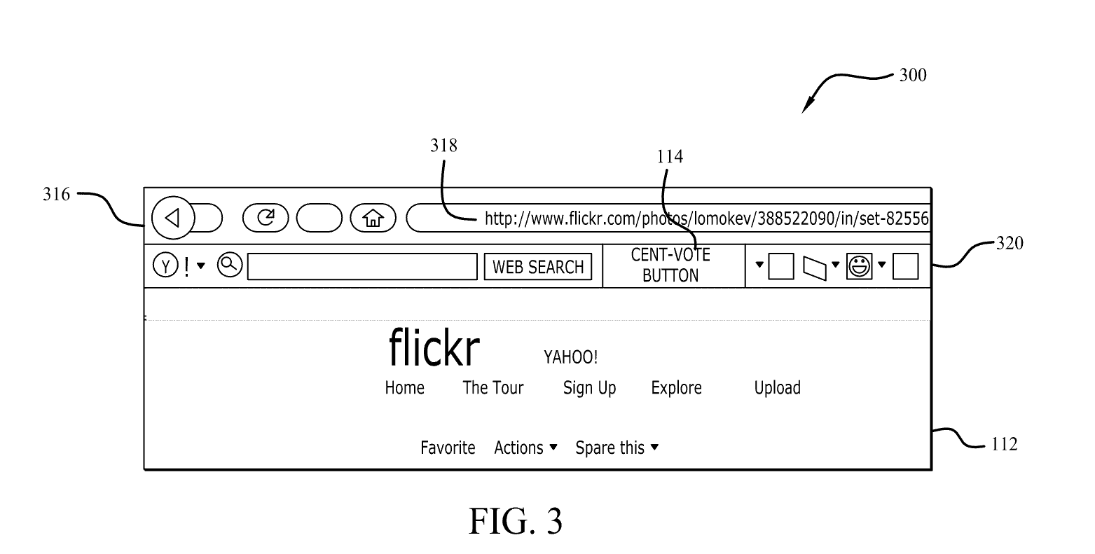

FIG. 3 is a block diagram of an example of a screen display 300 that displays a cent-vote button 114 in accordance with one embodiment. As seen from FIG. 3, the webpage 112 is displayed to a user, for example, in a web browser or an application that has associated therewith a toolbar 320. In this embodiment, the toolbar 320 has been installed as an added component to the web browser and the cent-vote button 114 is included in the toolbar 320. In another embodiment, the cent-vote button 114 can also be integrated directly into an application or the toolbar 316 of the web browser. As discussed supra, upon a user clicking the cent-vote button 114, the URL 318 displayed in the address bar of the web browser is transmitted to the cent-vote system 100 along with the user information. In different embodiments, the cent-vote button 114 can be configured to automatically log in an associated user into the cent-vote 100 system or it can prompt the user to log in to the cent-vote system 100, for example, via a pop-up window (not shown).

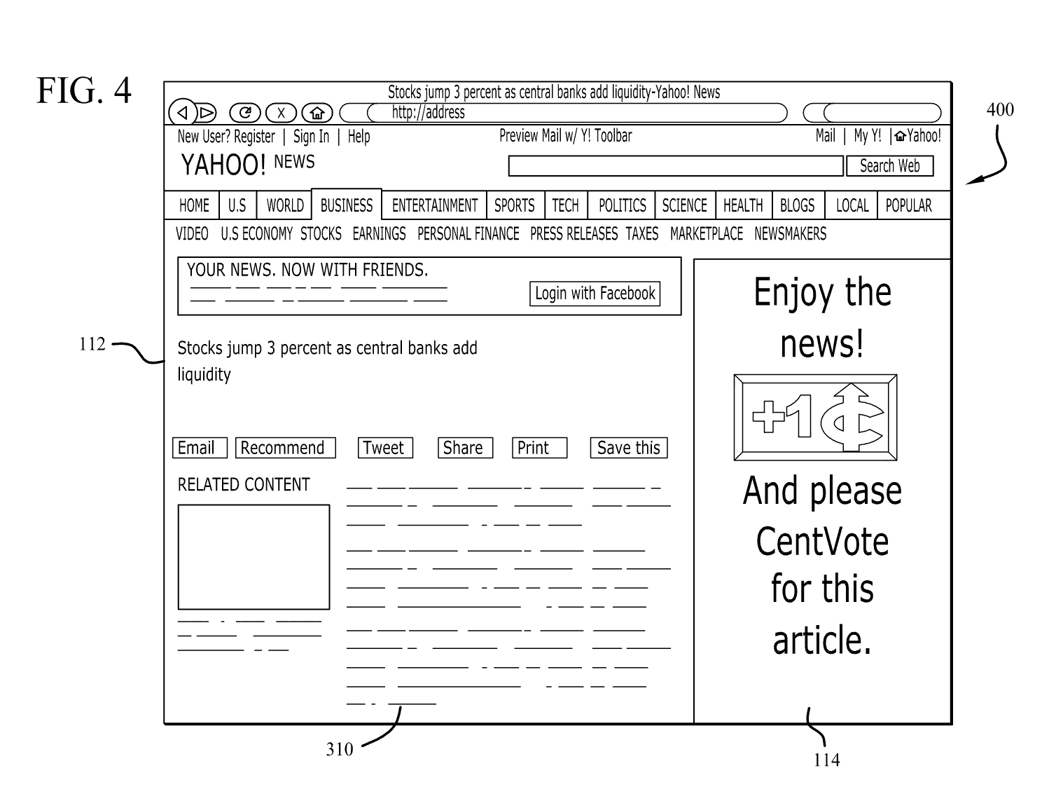

FIG. 4 is a block diagram of an example of a screen 400 that shows the placement of the cent-vote button 114 in accordance with one embodiment. The placement of the cent-vote button 114 in a web browser can also depend on a user's browser settings. For example, if the user has disabled pop-ups or advertisements in the web browser, the cent-vote button 114 can be included in the content of the webpage 112. In this embodiment, the cent-vote system 100 is configured to encourage an ad-blocking user to donate voluntarily after receiving the content 310.

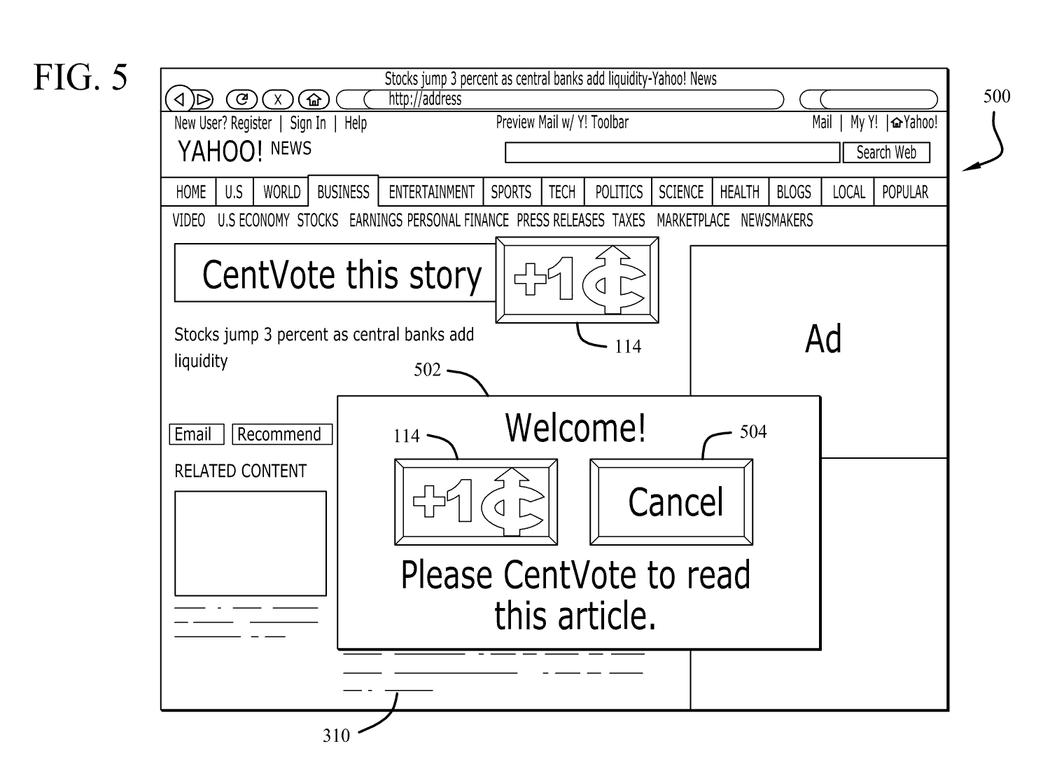

FIG. 5 is a block diagram of an example of a screen 500 that shows the placement of the cent-vote button 114 in accordance with an embodiment. In this embodiment, the user's browser settings are not configured to prevent display of advertisements. Therefore, user donation is requested by the cent-vote system 100 prior to providing the content via a pop-up window 502 comprising the cent-vote button 114. The pop-up window 502 also comprises a cancel button 504 thereby providing the user an opportunity to decline contribution. In either case, the user can be allowed to view the content 310 that has be obscured by the pop-up window 502. In one embodiment, the cent-vote system 100 can be configured to also include the cent-vote button 114 in the contents 310 of the webpage 112 so that the user can contribute to the publisher after reading the content 310. Thus, the cent-vote system 100 is configured to receive user donations to web pages prior to or after providing the content.

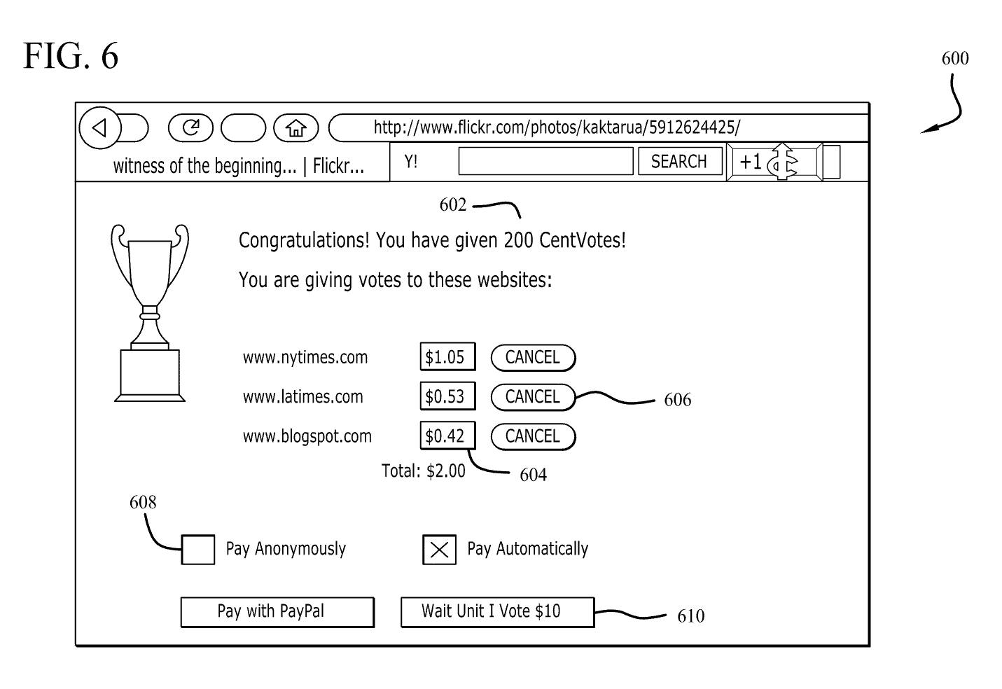

FIG. 6 is a block diagram of an example of a screen showing a review page 600 associated with a user account in the cent-vote system 100 in accordance with one embodiment. In different embodiments, the user can arrive at the review page 600 via a notification from the cent-vote system 100 upon a transaction condition being satisfied or the user may have arrived at the review page 600 by directly logging into the cent-vote system 100. As discussed supra, in one embodiment, the review module 230 of the analysis module 120 allows users to review their aggregated votes prior to confirming payments. The review page 600 is configured to show the aggregated votes cast by the user as seen at 602. In addition, the publishers/websites receiving the user's contributions and the amount contributed by the user to each website is also seen. In different embodiments, the review page 600 can be configured to allow the user to revise amount associated with each contribution shown in the text boxes 604 or it can display the amounts in a manner that cannot be changed by the user, for example, as text on the review page 600. In a further embodiment, the review page 600 can also include cancel buttons 606 so that users can cancel contributions to particular web sites at the time of review. In addition, in one embodiment, the user is also provided with an option to pay anonymously as shown at 608. The review page 600 can also include an option for users to postpone payments until a new threshold condition is reached. The new thresholds can be associated with specific dollar amounts or time or combinations thereof based on attributes associated with particular user accounts. In this case, the user can postpone payments until the user votes total an amount of ten dollars as shown at 610.

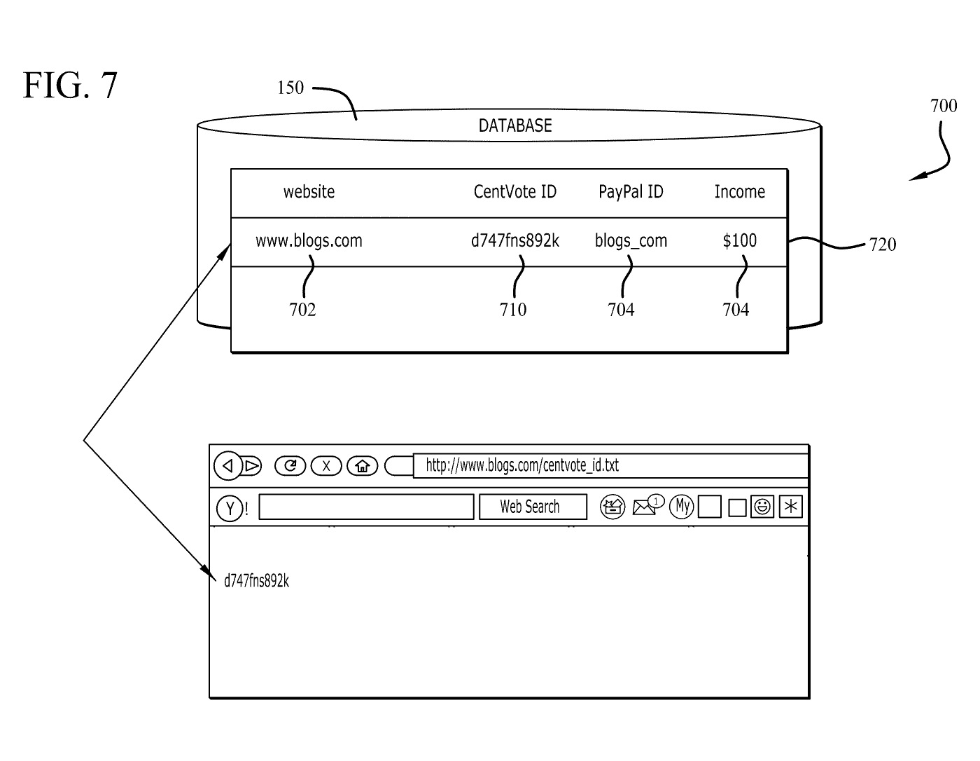

FIG. 7 is a schematic figure of a system 700 that facilitates websites to register with the cent-vote system 100. In order to collect funds obtained from users via the cent-vote system 100, the publishers/owners of websites can register with the cent-vote system 100 and obtain a cent-vote ID 710 which is stored in part of the cent-vote database 150. In addition, other publisher information such as the URL of the website 702, the income obtained 704 and account information such as the PayPal ID 706 can also be stored in, for example, a publisher table 720 of the cent-vote database 150. In order to be able to provide the funds aggregated in the account of the website 702, the cent-vote system 100 checks the website to verify if the cent-vote ID 710 has been embedded within the website 702. If yes, then the funds aggregated into its respective account can be credited via the corresponding PayPal ID 706, if not the account information, such as the PayPal ID is assumed to be false and the funds may not be credited.

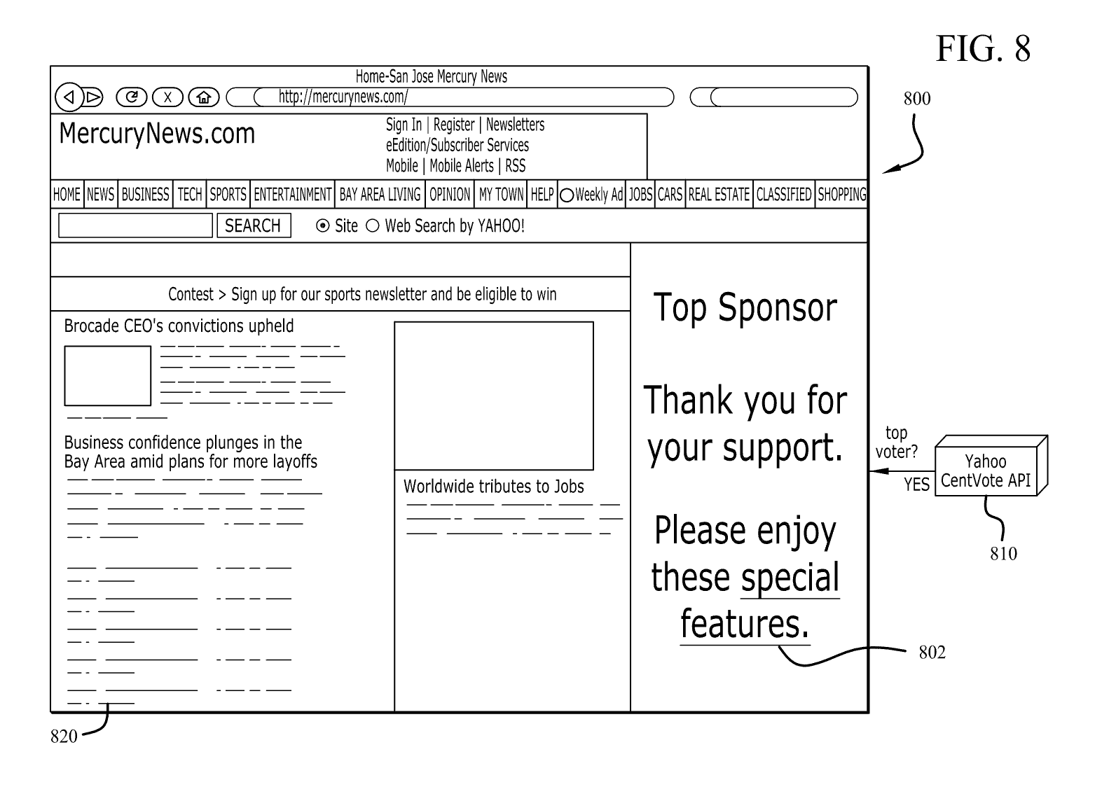

FIG. 8 is a block diagram of an example of a screen 800 showing a process of assigning special privileges to a top donor of a website. The cent-vote system 100 can provide cent-vote API 810 and donor information to website publishers in order to enable them to assign different privileges to different users based on their respective contributions to the website. In this embodiment, when a user logs in to the cent-vote system 100 either via clicking the cent-vote button 114 or has been automatically logged in, the cent-vote system 100 can check the cent-vote database 150 to determine if the logged in user is a top sponsor for the website 820 being currently browsed. If the user is a top donor for the website 820, a link 802 to the special features can be embedded into the content of the webpage 820. In different embodiments, the link 802 could lead the user to ad-free content, other ancillary information related to the topic being browsed or higher quality transmission, for example, better images. The cent-vote system 100 is thus configured to incentivize users to donate money to different websites and thus provides a two-way benefit for both content providers and users.

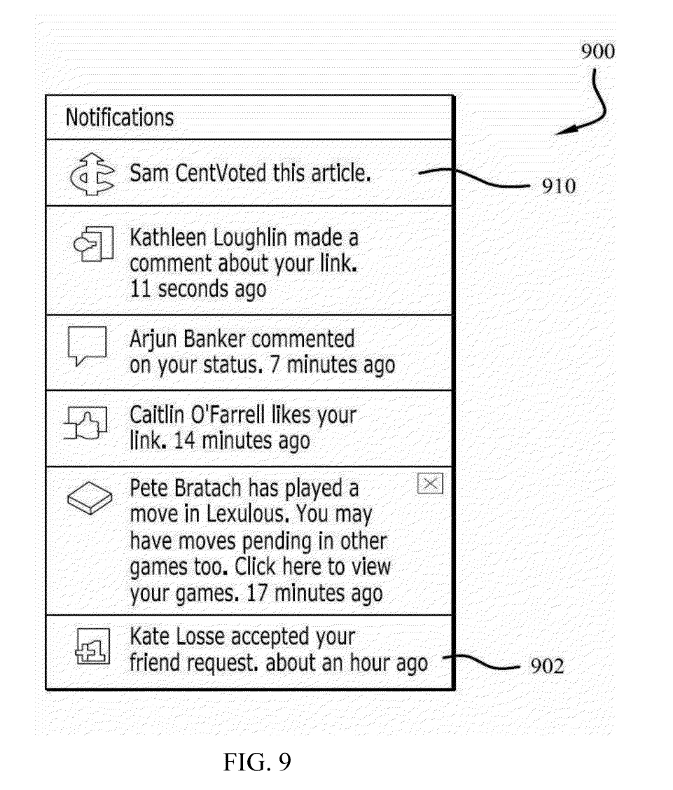

FIG. 9 is a block diagram of a screen 900 wherein content receiving cent-votes from users is transmitted to a user's social network in accordance with an embodiment. FIG. 9 shows a notification pane 902 wherein various notifications received by a user are displayed. One of the notifications 910 is from the cent-vote system 100 that the article currently being browsed by the user received a contribution via the cent-vote system 100 from one of user's social contacts. In a further embodiment, the cent-vote system 100 can be configured to receive and send notifications to social networking websites so that user votes can be transmitted (at the user's discretion) to their social networks as content recommendations. In another embodiment, the notifications received by the user can comprise links to articles that received contributions from user's social contacts.

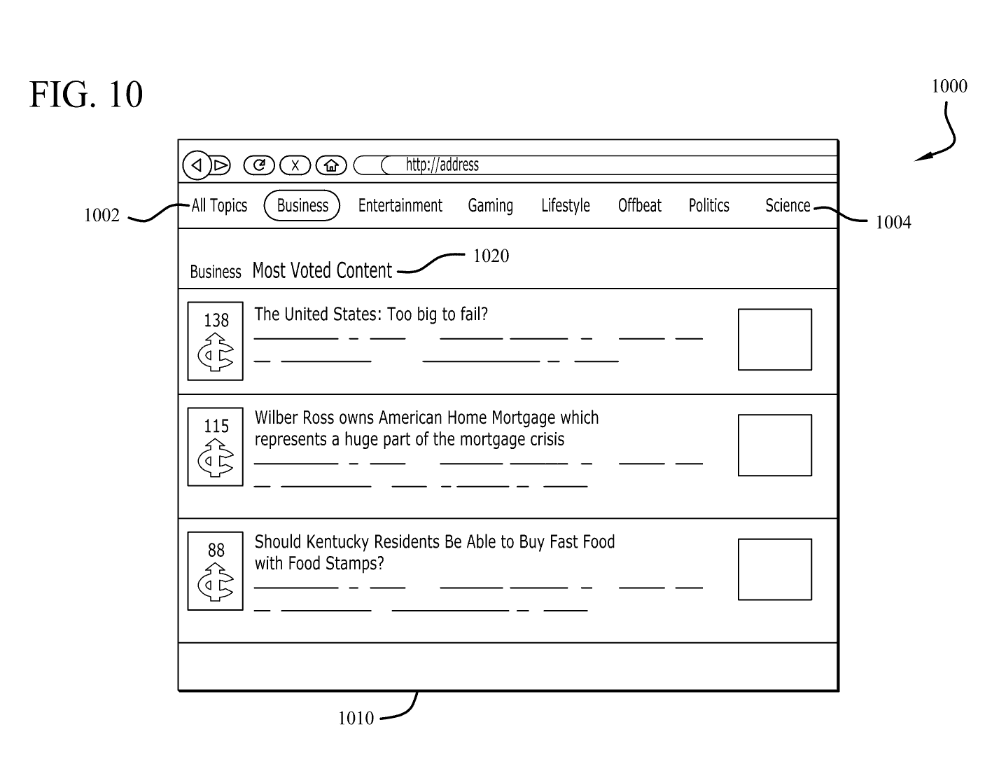

FIG. 10 is a block diagram of a screen 1000 that provides value added content to users in accordance with one embodiment thereby facilitating democratic recommendations by the recommendation module 140 of the cent-vote system 100. The recommendation module 140 can be configured to display the top ranked items among those collected from all the categories as shown at 1002 or the top ranked content items from each of different categories under respective tabs 1004. The items can be ranked based on the user votes received or the received micro-donation amounts. In different embodiments, only unique user votes can be counted regardless of the associated donation amounts or the number of user votes counted can be proportional to the donation amounts. In further embodiments, categories displayed under different tabs can be selected by a user or the categories that are most popular among the users of the cent-vote system 100 can be automatically selected. In FIG. 10, the content items are ranked in a descending order based on the number of user votes so that the top ranked items comprise items that have received most number of cent-votes as shown at 1020.

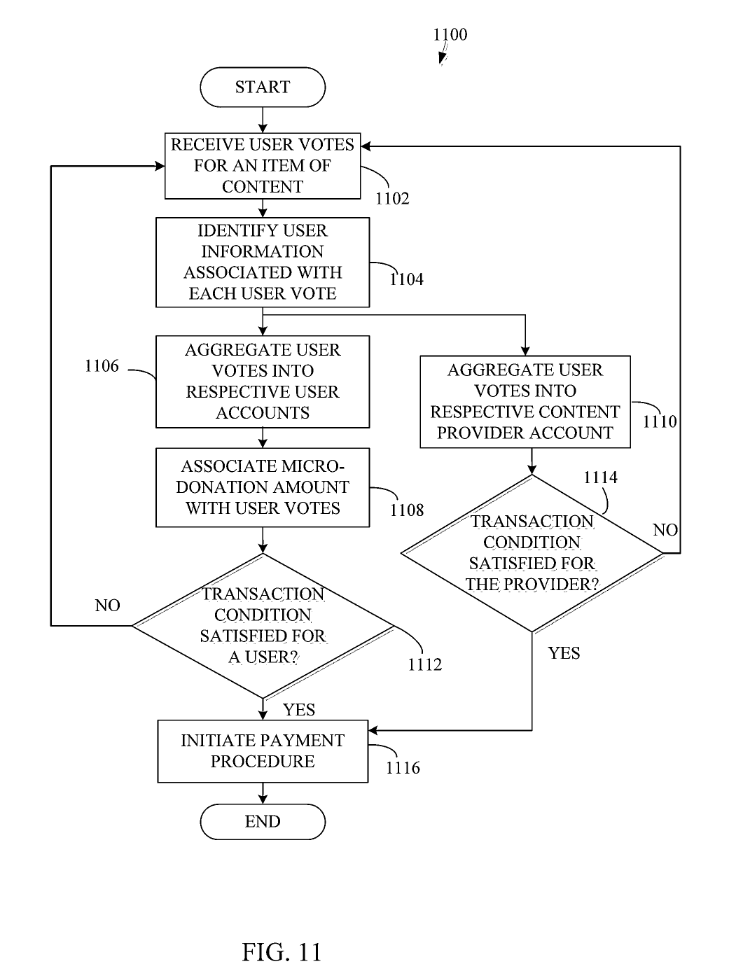

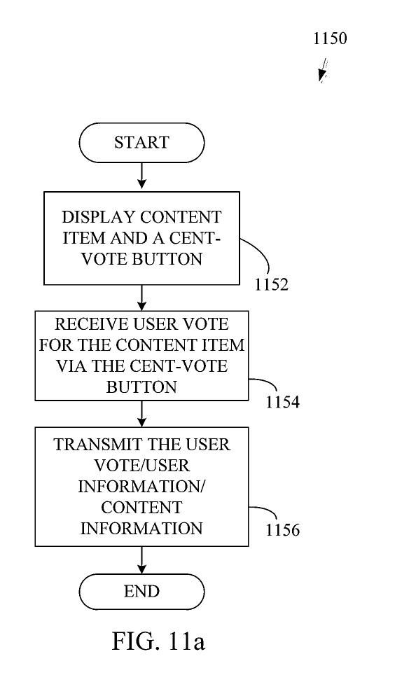

FIG. 11 shows a flowchart 1100 illustrating an embodiment of a method of facilitating micro-donations from users. The method begins at 1102 wherein user votes are received for at least one item of content. At 1104, the users associated with each of the received user votes are identified either directly from information received with the user vote or by requesting the information explicitly from the user, for example, by requesting the user to log in. At 1106 the user votes are aggregated into the respective user accounts associated with each of the received votes. The user votes are representative of monetary donations to the content provider. As discussed supra, different micro-donation amounts can be associated with different user votes based on user and/or content provider preferences. If no preferences are set by either the user or the content provider, a default amount is associated with the user votes Accordingly, a micro-donation amount is associated with each of the received votes as show at 1108. In addition, the user votes are also aggregated into another account associated with the provider/publisher of the content as shown at 1110. The content providers can register with the cent-vote system 100 in order to receive user donations and other benefits as described herein. At 1112, it is determined if a transaction condition is satisfied for at least one of the user accounts. In one embodiment, the transaction condition is satisfied if a certain predetermined time period has elapsed since the prior pay cycle for the user account or the publisher account. In another embodiment, the transaction condition is satisfied upon a certain predetermined threshold amount of donations being accumulated into the user or the publisher account. In a further embodiment, the threshold amount of donations aggregated in the user/publisher accounts can be preset to an amount that justifies the transaction costs associated with the payment process. In one embodiment, the payment process can be commenced for a user account if a predetermined minimum amount of donations remain after accounting for the transactions costs. By the way of illustration and not limitation, if $0.30 is accumulated in a user account and the transaction costs amount to $0.30 then the entire amount aggregated in the user account is taken up by the transaction costs and no amount can be donated to the content publishers. Hence, the payment process will not be initiated in this case and the process will return to step 1102 where votes from the user will continue to be received. Alternately, if $1.00 is accumulated or aggregated in the user account and the transaction costs amount to $0.30, then an amount of $0.70 can be passed on to different content providers designated by the user and hence, the payment process can be initiated in this case.

Similarly, as the user votes are aggregated into the content provider account at 1110, subsequently at 1114, it is determined if the transaction condition is satisfied for the provider account associated with the at least one item of content. If yes, the payment process can be initiated as shown at 1114. For example, it can be determined at 1114 that the transaction condition is satisfied if a certain predetermined minimum amount is aggregated in the content provider account after accounting for the transaction costs. Additionally, for a content provider account, the payment process can be initiated only if the micro-donation amount associated with different user votes are actually received from respective users. Based on these factors, if the transaction condition is not satisfied, the procedure returns to collecting user votes as shown at 1102. If the transaction condition is satisfied for any of the user accounts as shown at 1112 or the content provider account at 1114, the payment procedures are initiated for the respective accounts as shown at 1116. If the account is a user account, the payment process is initiated to charge the user for the aggregated amount whereas the payment process is initiated to credit at least part of the aggregated amount to an associated account for the content provider.

FIG. 11a is a flowchart 1150 illustrating an embodiment of a method of facilitating micro-donations from users while causing minimum disruption to the users. The method begins at 1152 wherein an item of content 116 is presented to the user. The item of content 116 can include text data, audio or video data or combinations thereof. In addition to the item of content 116, a cent-vote button 114 can be displayed which facilitates users to vote for and donate to the item of content 116. In one embodiment, the cent-vote button 114 can be displayed with the content in the same webpage. However, this requires the content provider to add additional code to the content page and to allocate space on the content page in order to incorporate the cent-vote button 114. Such additional efforts can discourage content providers from employing the cent-vote methodologies to receive donations. In one embodiment, the cent-vote button 114 can be displayed in a toolbar of the web browser or the toolbar of an application presenting the item of content to the user or a stand alone toolbar. In this embodiment, no extra coding is required by the content provider since the item of content itself will not include the cent-vote button 114. Moreover, the cent-vote button 114 will not be occupying any space on the content page although in an embodiment the button can appear as an overlay. In one embodiment, the cent-vote button 114 can be part of an add-on toolbar which is attached to the toolbar of the web browser. In one embodiment, the cent-vote button 114 can be a part of the web browser toolbar. Users may vote for the item of content 116 by clicking the cent-vote button 114. As detailed supra, clicking the cent-vote button 114 will automatically register the users' votes in their respective accounts without requiring explicit user log according to one embodiment. Accordingly, user votes are received as shown at 1154 and such votes are transmitted to the cent-vote system 100 in order to be recorded or aggregated in the users' accounts as shown at 1156. It can be appreciated that such automatic transmission of user votes and information related to the user votes can facilitate the users to stay on page viewing the item of content 116 even while registering their contributions to the item of content 116.

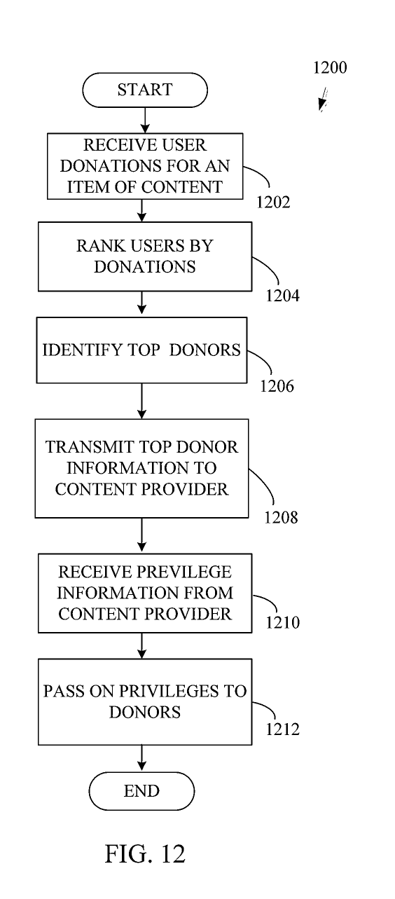

FIG. 12 is a flowchart 1200 illustrating an embodiment of a method of providing premium services from content providers to their respective top donors in accordance with an embodiment. The method commences at 1202 wherein user donations associated with user votes for an item of content are received. The users are ranked by their respective donations as shown at 1204 and at 1206, the top n (n being a natural number) donors are identified. The user ids or other identification information in accordance with respective preferences of the top n donors is transmitted to the content provider as shown at 1208. In one embodiment, premium content or special privileges are obtained from the content providers as shown at 1210, which are passed on to the top donors as shown at 1212. For example, the cent-vote button 114 can be configured to suppress advertisements for the remainder of the day on the webpage that received the user's contribution. It can be appreciated that steps 1210 and 1212 can be optional as the special privileges can be provided directly by the content provider when the user visits the webpage of the content provider. Various user privileges such as listing the top donors on the web pages of the content provider, providing web pages free of advertisements, other ancillary related content can be provided. The content providers are also able to generate revenues in addition to identifying user segments that are interested in their content and the particular content items and/or content categories that are generating interest/contributions from users. The feedback thus obtained can be used to improve content, content categorization based on topics or rank and content recommendations to the users.

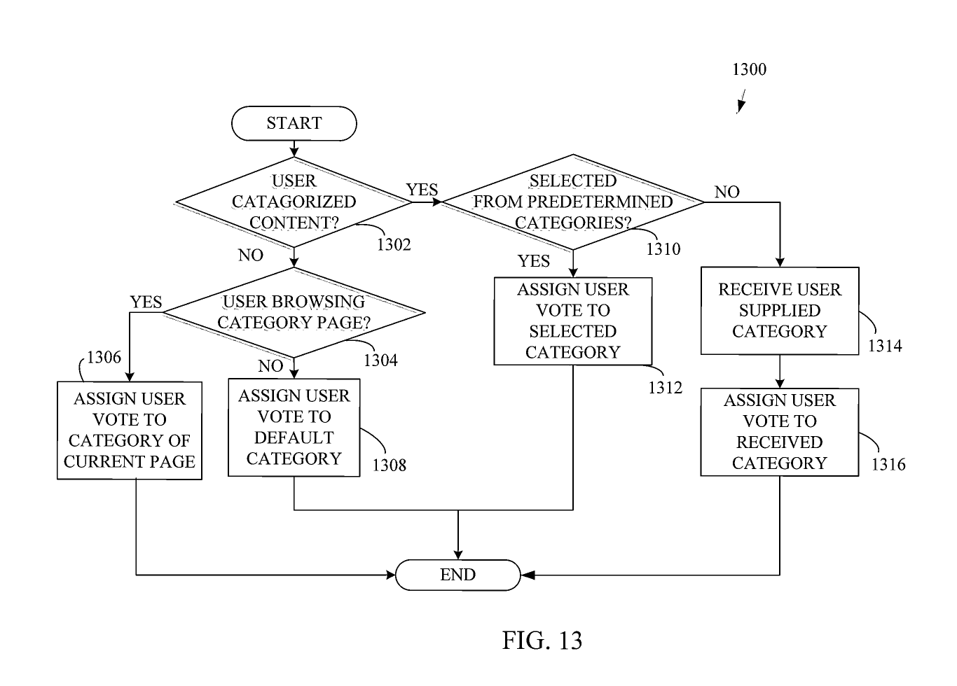

FIG. 13 is a flowchart 1300 that illustrates an embodiment of a method of recognizing popular content categories. The method begins at 1302 wherein it is determined if a user chose to categorize or tag an item of content when voting for the content item. This facilitates identifying the categories of content popular among the users in addition to identifying popular content. If the user has chosen not to categorize or tag the item, the method proceeds to step 1304 wherein it is determined if the user is browsing a topic page of the cent-vote system 100. If yes, the method proceeds to 1306 wherein the user vote is assigned to the current topic page. If it is determined at 1304 that the user is not browsing the topic page of the cent-vote system 100, the user vote is assigned to a default general category predefined within the cent-vote system 100 as shown at 1308 and the method terminates on the end block. If at 1302, the user has provided a category or tagged to the content item, the method proceeds to step 1310 wherein it is determined if the user selected the category or tags from those provided by the cent-vote system 100. In different embodiments, categories or tags can be provided by the content providers or they can be generated from within the cent-vote system 100 by employing automatic processes such as NPL (natural language processing) techniques or by human editors. In another embodiment, the category or tag may have been earlier provided by the user and stored within the cent-vote system 100. Thus, for each user account, various combinations of such content categories are listed for user selection. If the user has selected from the pre-existing categories/tags at 1310, the user vote is assigned to the selected category for that particular user as shown at 1312 and the process terminates at the end block. When the user returns to the cent-vote system 100 at a later time, the user will be able to locate the content item in the selected category. It can be appreciated that different users can choose to place the same content item in different categories in their respective accounts based on their respective perceptions/interests. If it is determined at 1310 the user has not selected from the pre-existing category, then the category or tag defined/generated or otherwise supplied by the user is obtained as shown at 1314. Based on user preferences, the newly generated category or tag for the content item can be made public, for example, as a suggested category for selection by other users in accordance with a further embodiment described infra. The content item is placed in the newly generated category and the user vote is assigned to the new category as shown at 1316. Therefore, the cent-vote system 100 is configured to identify popular content in addition identifying popular content categories as described herein thereby aiding the content producers/content providers to select items from appropriate content categories for presentation to different users.

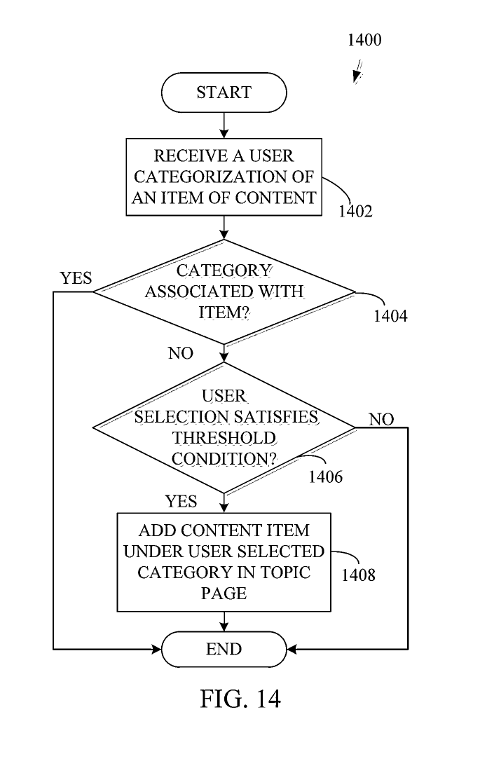

FIG. 14 is a flowchart 1400 that illustrates an embodiment of a method of categorizing content in accordance with one embodiment. The method begins at 1402 wherein categorization of an item of content by a user is received. As discussed herein, different users can classify an item of content under different categories for their respective accounts/profiles. The users can select from existing content categories or define new categories for various content items that they contribute to. Accordingly, the number of users classifying the item of content under different categories can vary. Based on the number of users categorizing a content item, new categories can be identified. Therefore, for each user categorization received at 1402, it is determined at 1404 if the category selected by the user is a category/topic already associated with the content item. If the category is already associated with the content item, the content item appears under the topic in the topic/category page of the cent-vote system 100 and hence, the process terminates at the end block. If, at 1404, it is determined that the category selected by the user is not associated with the content item, it is determined at 1406 if the selected user category satisfies a threshold condition. In particular, it is determined at 1406 if the number of users who selected the category selected by the user at 1404 as being appropriate for the content item exceeds a predetermined threshold number. If, at 1406, it is determined that the number of users classifying the content item under the user selected category is less than the predefined threshold number, the process terminates at the end block. It at 1406, it is determined that the number of users classifying the content item under the user selected category exceeds the predefined threshold number, the content item is added publicly for display as being relevant under the user selected category as shown at 1408. Consequently, the content item is now listed under the user selected category publicly within a topic page of the cent-vote system 100 in addition to other categories already associated therewith. Thus, the cent-vote system 100 is configured to employ user feedback in identifying topics or categories for content items or conversely content items for listing under various categories/topics as described herein.

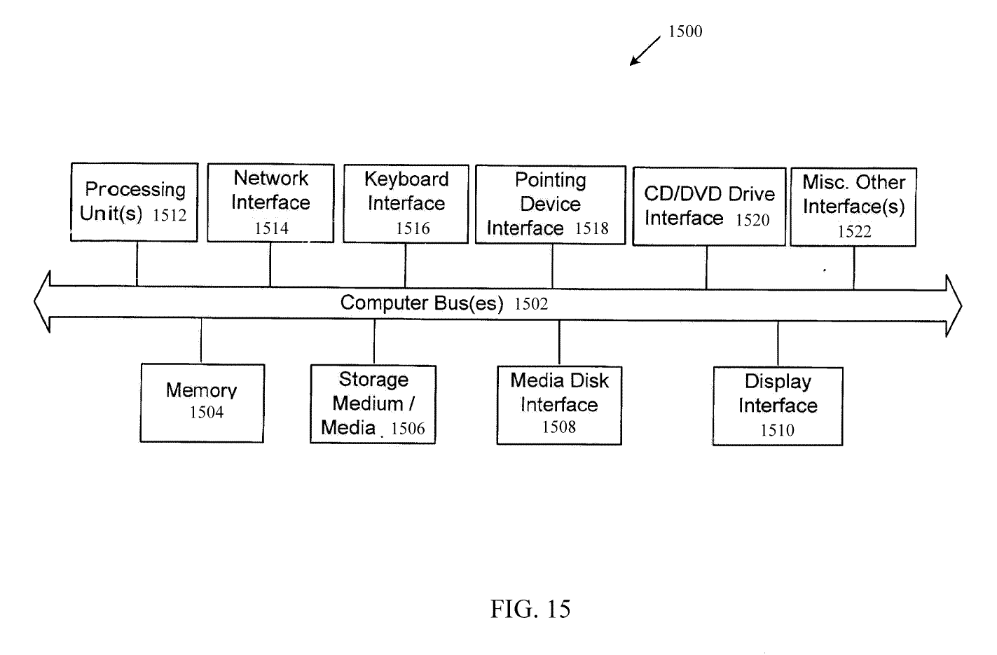

As shown in the example of FIG. 15, internal architecture of a computing device 1500 includes one or more processing units (also referred to herein as CPUs) 1512, which interface with at least one computer bus 1502. Also interfacing with computer bus 1502 are persistent storage medium/media 1506, network interface 1514, memory 1504, e.g., random access memory (RAM), run-time transient memory, read only memory (ROM), etc., media disk drive interface 1508, an interface 1520 for a drive that can read and/or write to media including removable media such as floppy, CD-ROM, DVD, etc., media, display interface 1510 as interface for a monitor or other display device, keyboard interface 1516 as interface for a keyboard, pointing device interface 1518 as an interface for a mouse or other pointing device, and miscellaneous other interfaces 1522 not shown individually, such as parallel and serial port interfaces, a universal serial bus (USB) interface, and the like.

Memory 1504 interfaces with computer bus 1502 so as to provide information stored in memory 1504 to CPU 1512 during execution of software programs such as an operating system, application programs, device drivers, and software modules that comprise program code, and/or computer-executable process steps, incorporating functionality described herein, e.g., one or more of process flows described herein. CPU 1512 first loads computer-executable process steps from storage, e.g., memory 1504, storage medium/media 1506, removable media drive, and/or other storage device. CPU 1512 can then execute the stored process steps in order to execute the loaded computer-executable process steps. Stored data, e.g., data stored by a storage device, can be accessed by CPU 1512 during the execution of computer-executable process steps.

Persistent storage medium/media 1506 is a computer readable storage medium(s) that can be used to store software and data, e.g., an operating system and one or more application programs. Persistent storage medium/media 1506 can also be used to store device drivers, such as one or more of a digital camera driver, monitor driver, printer driver, scanner driver, or other device drivers, web pages, content files, playlists and other files. Persistent storage medium/media 1506 can further include program modules and data files used to implement one or more embodiments of the present disclosure.

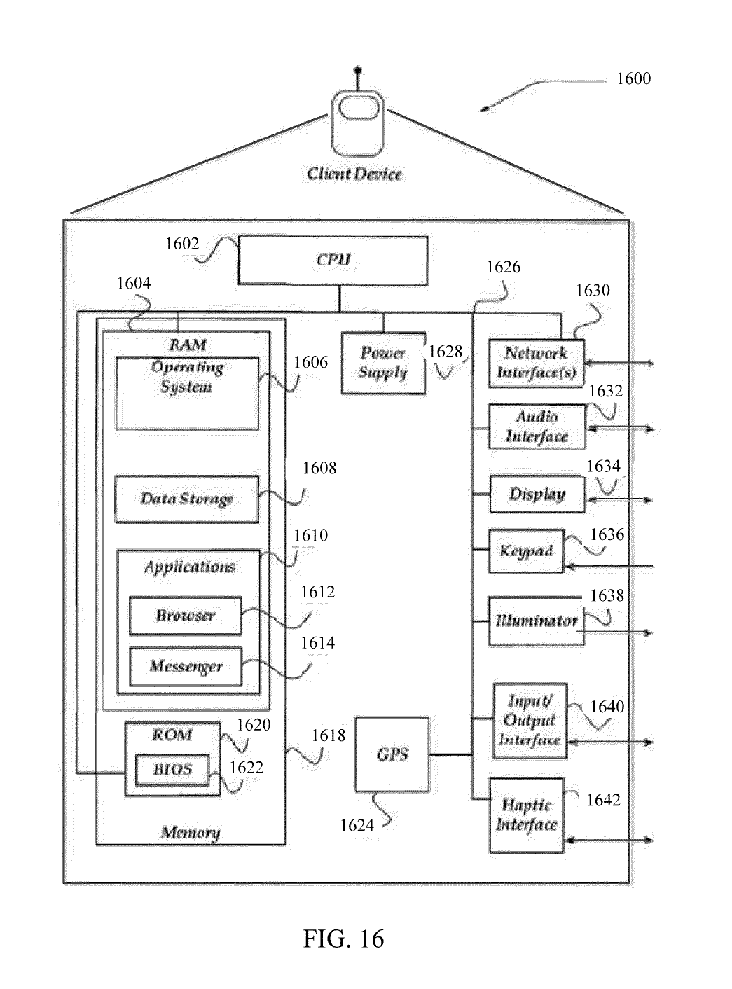

FIG. 16 is a schematic diagram illustrating a client device implementation of a computing device in accordance with embodiments of the present disclosure. A client device 1600 may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. The client device can include standard components such as a CPU 1602, power supply 1628, a memory 1618, ROM 1620, BIOS 1622, network interface(s) 1630, audio interface 1632, display 1634, keypad 1636, illuminator 1638, I/O interface 1640. Claimed subject matter is intended to cover a wide range of potential variations. For example, the keypad 1636 of a cell phone may include a numeric keypad or a display 1634 of limited functionality, such as a monochrome liquid crystal display (LCD) for displaying text. In contrast, however, as another example, a web-enabled client device 1600 may include one or more physical or virtual keyboards 1636, mass storage, one or more accelerometers, one or more gyroscopes, global positioning system (GPS) 1624 or other location identifying type capability, Haptic interface 1642, or a display with a high degree of functionality, such as a touch-sensitive color 2D or 3D display, for example. The memory 1618 can include Random Access Memory 1604 including an area for data storage 1608.

A client device may include or may execute a variety of operating systems 1606, including a personal computer operating system, such as a Windows, iOS or Linux, or a mobile operating system, such as iOS, Android, or Windows Mobile, or the like. A client device 1600 may include or may execute a variety of possible applications 1610, such as a client software application 1614 enabling communication with other devices, such as communicating one or more messages such as via email, short message service (SMS), or multimedia message service (MMS), including via a network, such as a social network, including, for example, Facebook, Linkedln, Twitter, Flickr, or Google+, to provide only a few possible examples. A client device 1600 may also include or execute an application to communicate content, such as, for example, textual content, multimedia content, or the like. A client device 1600 may also include or execute an application 1612 to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising
receiving, by a computing device, user votes associated with at least one item of content;
aggregating, by the computing device, the received user votes into respective user accounts;
adding, by the computing device, upon receipt of each of the user votes, a respective micro-donation amount associated with each of the user votes to a respective user account for future debit and to an account of a respective content provider providing the at least one item of content for future credit;
determining, by the computing device, if a transaction condition is satisfied for at least one of the user accounts;
effectuating payment, by the computing device, for a respective aggregated micro-donation amount upon the transaction condition being satisfied.

2. The method of claim 1, further comprising, aggregating, by the computing device,
the respective micro-donations associated with the user votes received for the at least one item of content into a respective content provider account.

3. The method of claim 2, further comprising:
determining, by the computing device, if a transaction condition is satisfied for the content provider account; and
providing, by the computing device, at least part of the aggregated micro-donations to a content provider of the at least one item of content upon the transaction condition being satisfied for the content provider account.

4. The method of claim 1, further comprising, facilitating review, by the computing device, of the aggregated micro-donations by a respective user of the at least one user account.

5. The method of claim 4, wherein the at least one user account is charged for the aggregated micro-donation amount only upon receiving confirmation to charge the aggregated micro-donation amount after the review by the respective user.

6. The method of claim 1, wherein the transaction condition is satisfied upon passage of a preset time period.

7. The method of claim 1, wherein the transaction condition is satisfied when the aggregated micro-donations exceed a predetermined threshold amount.

8. The method of claim 7, the threshold amount is set such that at least a predetermined amount of the aggregated micro-donations from the at least one user account can be provided to respective content publishers after accounting for transactions costs.

9. The method of claim 1, the micro-donation amount associated with each of the user votes is determined by a content provider that provided the at least one item of content.

10. The method of claim 1, the micro-donation amount associated with each of the user votes is determined by respective users.

11. The method of claim 1, further comprising, receiving, by the computing device, user identification information and URL (Universal Resource Locator) of the at least one item of content automatically along with respective user votes.

12. The method of claim 1, effectuating payment by the computing device, further comprises, communicating, by the computing device, with third party payment systems.

13. A computing device comprising:
a processor;
a storage medium for tangibly storing thereon program logic for execution by the processor, the program logic comprising:
receiving logic, executed by the processor, for receiving user votes associated with at least one item of content;
aggregating logic, executed by the processor, for aggregating the received user votes into respective user accounts;
associating logic, executed by the processor, for associating a respective micro-donation amount with each of the user votes, such that upon receipt of each of the user votes, the respective micro-donation amount is added to a respective user account for future debit and to an account of a respective content provider providing the at least one item of content for future credit;
determining logic, executed by the processor, for determining if a transaction condition is satisfied for at least one of the user accounts;
payment effectuating logic, executed by the processor, for effectuating payment for respective aggregated micro-donation amount upon the transaction condition being satisfied.

14. The computing device of claim 13, the storage medium further comprising, review logic, executed by the processor, for providing a review of the aggregated user votes and associated micro-donation amounts to a respective user of the at least one user account.

15. The computing device of claim 13, the aggregating logic further comprising, logic for aggregating, by the processor, the micro-donations associated with the user votes received for the at least one item of content into a respective content provider account.

16. The computing device of claim 13, the determining logic, further comprising, logic for determining, by the processor, if a transaction condition is satisfied for the content provider account.

17. The computing device of claim 13, further comprising:
providing logic, executed by the processor, for providing at least part of the aggregated micro-donations to a content provider of the at least one item of content upon the transaction condition being satisfied for the content provider account.

18. The computing device of claim 13, the receiving logic further comprising:
logic for receiving, by the processor, respective user identification information and URL (Universal Resource Locator) of the at least one item of content automatically along with the user votes.

19. A computer readable storage medium, having stored thereon, instructions which when executed by a processor, cause the processor to:
receive, user votes associated with at least one item of content;
aggregate, the received user votes into respective user accounts;
add, upon receipt of each of the user votes, a respective micro-donation amount associated with each of the user votes to a respective user account for future debit and to an account of a respective content provider providing the at least one item of content for future credit;
determine, if a transaction condition is satisfied for at least one of the user accounts;
effectuating payment for respective aggregated micro-donation amount upon the transaction condition being satisfied.

20. The medium of claim 19, further comprising instructions that cause the processor to,
aggregate the respective micro-donations associated with the user votes received for the at least one item of content into a respective content provider account.

21. The medium of claim 20, further comprising instructions that cause the processor to,
determine, if a transaction condition is satisfied for the content provider account; and
provide, at least part of the aggregated micro-donations to a content provider of the at least one item of content upon the transaction condition being satisfied for the content provider account.

22. The medium of claim 19, further comprising instructions that cause the processor to:
facilitate review of the aggregated micro-donations by a respective user of the at least one user account.

23. The medium of claim 22, further comprising instructions that cause the processor to:
charge the at least one user account for the aggregated micro-donation amount only upon receiving confirmation to charge the aggregated micro-donation amount after the review by the respective user.

24. The medium of claim 19, wherein the transaction condition is satisfied upon passage of a preset time period.

25. The medium of claim 19, wherein the transaction condition is satisfied when the aggregated micro-donations exceed a predetermined threshold amount.

26. The medium of claim 19, further comprising instructions that cause the processor to, receive user identification information and URL (Universal Resource Locator) of the at least one item of content automatically along with respective user vote.

27. A method comprising
displaying, by a computing device, an item of content and a button that records a user vote indicative of monetary donation for the item of content by a user;
receiving, by the computing device, a user vote for the item of content; and
transmitting, by the computing device, the received user vote, respective user information and information regarding the item of content to a server.

28. The method of claim 27, wherein the receiving and transmitting steps are executed by the computing device while displaying uninterruptedly, the item of content to the user.

29. The method of claim 27, wherein the button is displayed as part of a toolbar of a web browser displaying the item of content.

30. The method of claim 27, wherein the button is comprised within the item of content.

31. The method of claim 27, further comprising, displaying, by the computing device, a notification associated with charging a user account for monetary donations made by the user, upon satisfaction of a transaction condition.

32. A computer readable storage medium, having stored thereon, instructions which when executed by a processor, cause the processor to:
display an item of content and a button that record a user vote indicative of monetary donations for the item of content by a user;
receive a user vote for the item of content; and
transmit the received user vote, respective user information and information regarding the item of content to a server.
